(19) United States
(12) Patent Application Publication
(10) Pub. No.: US 2011/0154353 A1
(43) Pub. Date: Jun. 23, 2011

(54) Demand-Driven Workload Scheduling Optimization on Shared Computing Resources

(75) Inventors: Michael Theroux, Milford, NH (US); Jeff Piazza, Wellesley, MA (US); David Solin, Austin, TX (US)

(73) Assignee: BMC SOFTWARE, INC., Houston, TX (US)

(21) Appl. No.: 12/772,047

(22) Filed: Apr. 30, 2010

Related U.S. Application Data
(60) Provisional application No. 61/289,359, filed on Dec. 22, 2009.

(51) Int. Cl. G06F 9/50

(52) U.S. Cl. 718/104

(57) ABSTRACT

Systems and methods implementing a demand-driven workload scheduling optimization of shared resources used to execute tasks submitted to a computer system are disclosed. Some embodiments include a method for demand-driven computer system resource optimization that includes receiving a request to execute a task (said request including the task's required execution time and resource requirements), selecting a prospective execution schedule meeting the required execution time and a computer system resource meeting the resource requirement, determining (in response to the request) a task execution price for using the computer system resource according to the prospective execution schedule, and scheduling the task to execute using the computer system resource according to the prospective execution schedule if the price is accepted. The price varies as a function of availability of the computer system resource at times corresponding to the prospective execution schedule, said availability being measured at the time the price is determined.

### RELATED APPLICATIONS

The present application claims priority to U.S. Provisional Patent Application No. 61/289,359 filed on Dec. 22, 2009 and entitled “System and Method for Market-Driven Workload Scheduling Optimization on Shared Computing Resources,” which is hereby incorporated by reference.

### BACKGROUND

“Cloud Computing” has become a very visible technology in recent years. Amazon, Google, and many other companies have established various types of clouds in order to provide users with a highly scalable computing infrastructure. These clouds, frequently implemented using very large collections of servers or “server farms,” service a variety of needs ranging from large scale data storage to execution of virtual machines. One issue faced by providers of a public cloud infrastructure, or by any operator of a large, shared computer infrastructure, is how to efficiently utilize and distribute the workload across the available system resources. Most computer systems will have peak load times, while at other times valuable resources may go unused. Examples of such resources include, but are not limited to:

CPU (e.g., FLOPS or MWIPS1, or as indicated in VMware tools, MHz)

Volatile memory (e.g., RAM)

Storage (e.g., hard-disk space)

Network bandwidth

Power consumption

Database utilization

Many large systems execute workload scheduler software to better utilize the available system resources. As computer systems have continued to provide increasingly larger processing capacities, however, the numbers of tasks scheduled for execution have also continued to increase. A large mainframe computer or server farm, for example, may have hundreds or even thousands of tasks scheduled for execution at any given point in time. With so many tasks to contend with and a finite set of resources, scheduling tasks such that all the operational constraints are met can be daunting. When such constraints cannot all be met, the workload scheduler software must choose which task requests to attempt to satisfy, deferring or even declining those task requests which cannot be met in the requested time frame. The ability of a workload scheduler to make appropriate choices among the many possible schedules depends upon the scheduler's access to relevant information about each task's scheduling requirements, including whether and how the task may be rescheduled. When resources become overcommitted, resource scheduling problems can be overshadowed by the related but different problem of optimally choosing, from among competing tasks, those task scheduling requests that will actually be fulfilled and those that will not.

Existing workload schedulers may thus not be able to adequately distribute the load at peak times of system resource utilization (wherein there may be conflicting user priorities) and troughs in utilization (wherein capacity may exceed demand). Further, existing methods of workload scheduling optimization tend to focus on the identification of processing bottlenecks and manual task ordering without taking into account which task schedules may provide greater overall value or utility. Thus, existing workload schedulers may also not adequately address situations where resources become overcommitted.

### SUMMARY

The present disclosure describes systems and methods that utilize user-provided resource and scheduling task metadata to automatically vary the pricing of tasks submitted to a computer system. The variations in price operate to create a demand-driven schedule optimization of the computer system's workload. The disclosed systems and methods determine an optimal scheduling of each task, as well as an estimated pricing of the computer time charged for executing each task. As users schedule jobs for execution, resources already allocated to scheduled tasks and measured performance data for the system are aggregated by a workload scheduler to produce a measure of the current and projected utilization of the system's resources over time. The aggregated information is used by the workload scheduler to vary the price charged to users that submit new tasks for execution. A calculated price is presented to a user, allowing the user to submit the job as originally scheduled or vary the scheduling options so as to lower the cost of executing the task. Such pricing variations are designed to discourage system users from scheduling tasks during periods of high projected utilization of the system and encourage the scheduling of tasks during periods of low projected utilization. Users will naturally schedule their work during times that will be the most cost-effective for them. The users thus produce a market/demand-driven scheduling optimization that distributes the demand for the limited shared resources of the computer system over time.

In at least some embodiments, the pricing variations are further designed to encourage users to allow a degree of flexibility in scheduling their tasks by permitting the workload scheduler to vary the scheduled start, execution and end times of their tasks as needed to better utilize the system's resources. In such embodiments, the system has added flexibility to keep prices down by leveling peak utilization spikes through the dynamic re-scheduling of workloads within their user-specified time-boundaries. Various analysis techniques may be applied to the reservation schedule so as to present the lowest (and hence, most competitive) possible price for every new workload scheduling request.

### BRIEF DESCRIPTION OF THE DRAWINGS

FIG. 1 illustrates an example system for performing demand-driven workload scheduling optimization.

FIG. 2 illustrates a block diagram of the reservation system of FIG. 1.

FIG. 3 illustrates an example method for implementing the demand-driven workload scheduling optimization performed by the system in FIG. 1.

FIG. 4 illustrates a graph describing an example pricing model that may be used by the reservation system of FIG. 2.

FIG. 5 illustrates an example of a computer system suitable for executing software that performs at least some of the functionality described herein.

### DETAILED DESCRIPTION

The present disclosure describes systems and methods that implement a demand-driven workload scheduling optimization of shared resources used to execute tasks submitted to a computer system. These methods further implement scheduling tasks designed to optimize prices offered for new workloads in a resource-constrained environment. This optimization results in the demand-optimized use of the resources of the computer system. The scheduled tasks may include, for example, any of a variety of software programs that execute individually, separately and/or in conjunction with each other, and may be submitted as executable images, as command language scripts and/or as job control images that control the execution of one or more software programs.

In the interest of clarity, not all features of an actual implementation are described in the present disclosure. It will of course be appreciated that in the development of any such actual implementation (as in any development project), numerous decisions must be made to achieve the developers' specific goals (e.g., compliance with system- and business-related constraints), and that these goals will vary from one implementation to another. It will further be appreciated that such development effort might be complex and time-consuming, but would nevertheless be a routine undertaking for those of ordinary skill in the art having the benefit of this disclosure. Moreover, the language used in the present disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiments is included in at least one embodiment of the invention, and multiple references to “one embodiment” or “an embodiment” should not be understood as necessarily all referring to the same embodiment.

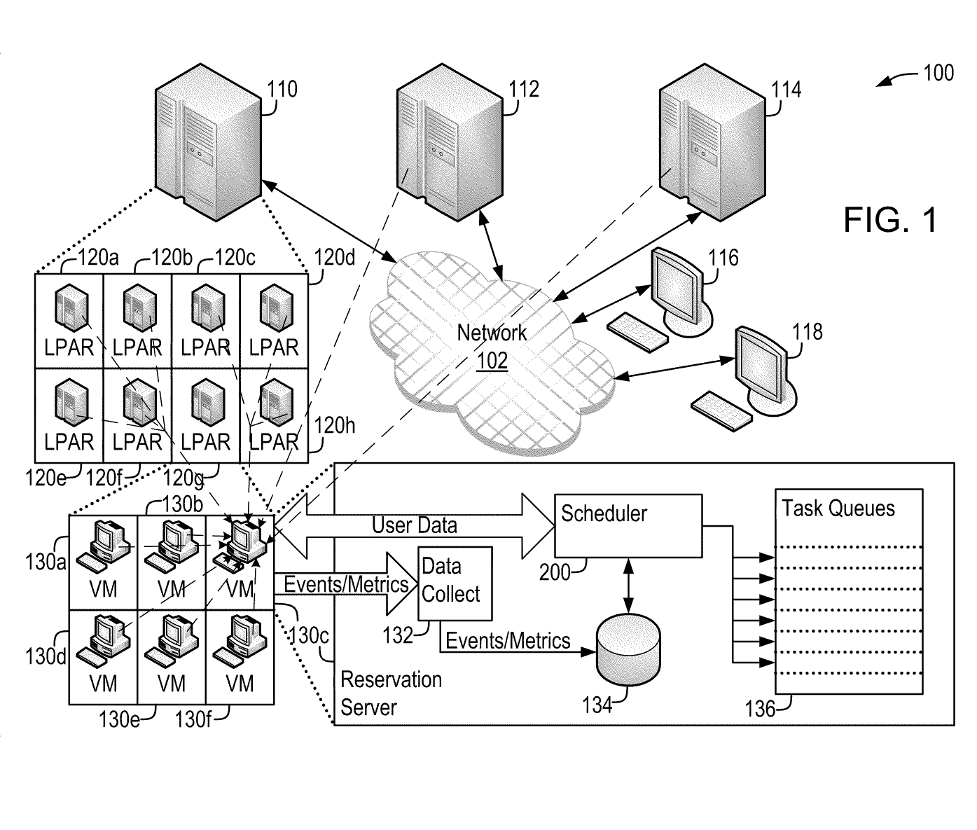

FIG. 1 illustrates computer system 100, which performs the above-described scheduling and scheduling optimization in accordance with at least some embodiments. System 100 includes mainframe computer systems 110, 112 and 114, each of which represents a potential source of event messages and system metric data. System metrics may include, for example, available network bandwidth, processing throughput and utilization, available memory and storage space and number of available partitions and virtual machines. Event messages may include, for example, notifications triggered when one or more system metrics conform to an event criterion such as a system metrics value exceeding a threshold (e.g., available memory dropping below a pre-defined level) or when several system metrics indicate that several events have occurred within a window of time or in a specific sequence (e.g., multiple data access failures possibly indicating a failed or soon to fail disk drive). Those of ordinary skill in the art will recognize that the embodiments described herein can incorporate many other system metrics and events, and all such system metrics and events are contemplated by the present disclosure.

Mainframe 110 shows an example of how each mainframe of FIG. 1 may be subdivided into logical partitions (LPARs) 120a-120h. Each partition may subsequently operate as a host system for one or more guest virtual machines, such as virtual machines (VMs) 130a-130f hosted on logical partition 120g. All of the mainframes, logical partitions and virtual machines each represent a potential source of events and system metric data, which in the example embodiment shown are routed to a single reservation server. The flow of event messages and system metric data is represented by the dashed arrows originating from the various sources, which are all directed to a reservation server implemented using virtual machine 130c. Although a virtual machine is used to host the reservation server function in the example shown, any of a number of real or virtual host machines may be used, and all such host machines are contemplated by the present disclosure.

Continuing to refer to the example system of FIG. 1, events and sample metric data (Event/Metrics) are received by data collection module (Data Collect) 132, which is stored as resource utilization data on non-volatile storage device 134. Data collection module 132, as well as other modules described throughout the present disclosure, may be implemented within management station 130c in software, hardware or a combination of hardware and software. In at least some embodiments, the system metric data includes unsolicited periodic data samples transmitted by a system component, and may also/alternatively include data samples provided in response to periodic requests issued by data collection module 132. The system components may include any hardware and/or software component within the system of FIG. 1.

Scheduler module 200 interacts with users of the system via a user interface presented at a user workstation (e.g., a graphical user interface via user stations 116 and 118) to accept new task requests from the user. Users provide scheduler module 200 with scheduling and resource requirements for their respective tasks, which scheduler module 200 combines with the scheduling and resource requirements of previously scheduled jobs and with current resource utilization data stored on non-volatile storage device 134 to determine a price for running a user's task. Tasks may be scheduled by the user for immediate execution or for execution starting at a later time. After calculating the price, scheduler module 200 presents the price to the user and can optionally present alternative scheduling and resource alternatives that may lower the cost to the user. The user may accept the price of the task as scheduled, reject the price without submitting the task for execution, or change the scheduling and resource requirements and submit the changes for a new price computation.

If the user accepts an offered price for a task, databases stored on non-volatile storage device 134 and used to track scheduled tasks are updated, and the user's task is submitted by scheduler module 200 for execution via one of job queues 136. After the task has executed, additional surcharges and/or discounts can be applied by scheduler module 200 to the user's final cost based upon actual measured resource utilization. By providing a dynamic pricing structure that is based upon current and projected resource utilization of a system, pricing can be used as an incentive to steer users of the system away from peak utilization times of the system and towards low utilization times. For example, pricing may be used to steer users away from executing tasks immediately and towards scheduling their tasks for delayed execution at a later time. A user's task may cost less if scheduled for delayed execution later in the evening (when resources are used less and cost less) rather than immediately in the middle of the work day (when utilization and prices are higher). Additional discounts may be offered to further encourage users to schedule their tasks well in advance (e.g., scheduling a task on Friday to execute over an upcoming weekend during late evening hours rather than scheduling a task for immediate execution first thing on Monday morning). Pricing may also be used to incentivize users to avoid fixed scheduling and resource requests, instead allowing the system to schedule their tasks within a window of time using varying ranges of resource (e.g., a larger time window that allows execution on a slower processor if a faster processor is not available). Pricing may further be used to encourage users to allow their tasks to be started, paused and resumed again one or more times within an overall time window larger than the total time required for the task. Such flexibility enables the system to shift lower priority tasks as needed to accommodate tasks with less flexible scheduling and resource requirements.

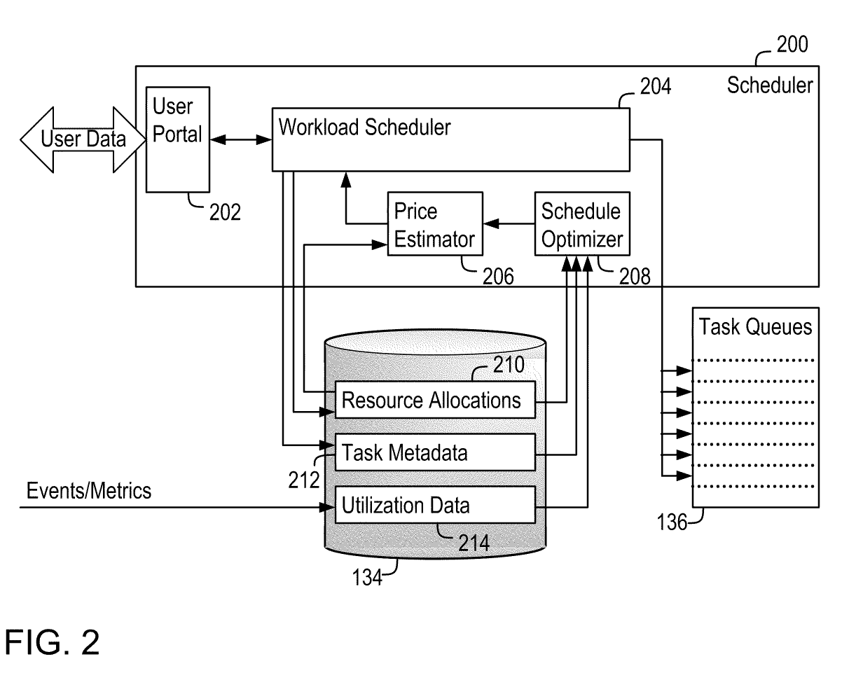

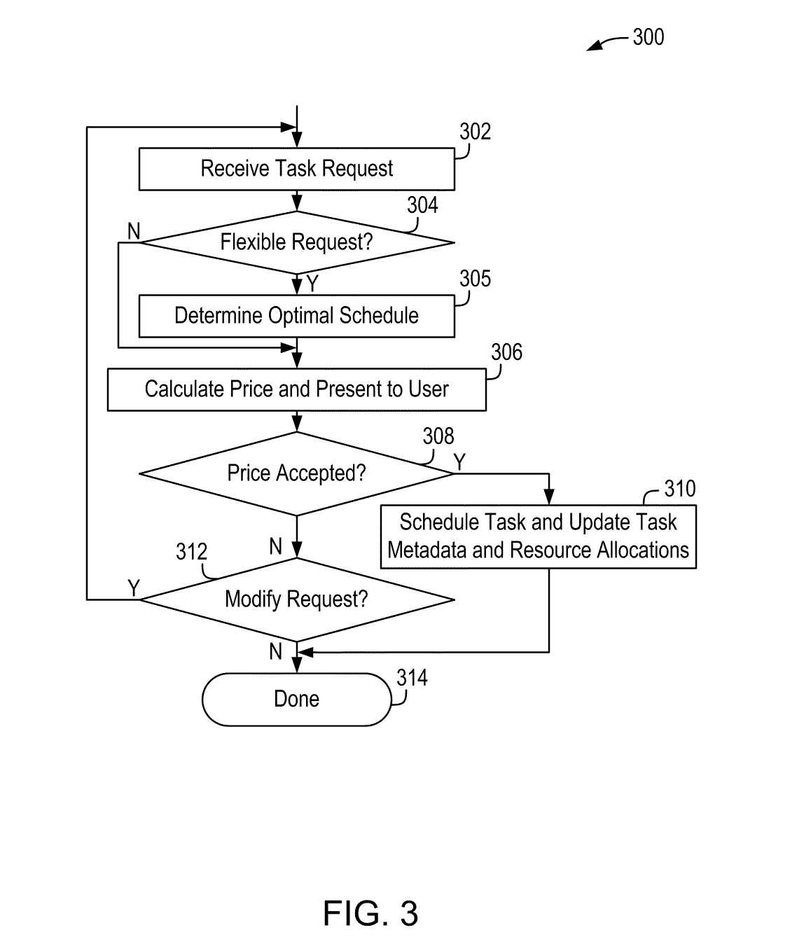

FIG. 2 illustrates a more detailed block diagram of scheduler module 200 and of the data stored on non-volatile storage device 134 and used by scheduler module 200. Scheduler module 200 includes user portal module 202, workload scheduler module 204, price estimator module 206 and scheduler optimizer module 208. Referring now to both FIG. 2 and method 300 of FIG. 3, information describing the resource and scheduling requirements of tasks to be submitted by a user (User Data) is received by user portal module 202 (block 302). This information is forwarded to workload scheduler 204 and stored as task metadata 212. Task metadata 212 includes both a private and a public component. The private component includes the task-specific metadata provided by the user (i.e., task-specific scheduling and resource requirements), which is only exposed to scheduler 200. The public component includes the aggregated data which is exposed as the available price presented to any user submitting a task request. The actual price paid for a specific task execution, however, remains private (i.e., only exposed to scheduler 200).

User portal module 202 interacts with the user to provide data to, and receive data from, a user operating a user station (e.g., via a graphical user interface presented at user station 118 of FIG. 1). If the user provides a task request with a flexible schedule and/or flexible resource requirements (block 304), schedule optimizer module 208 accesses resource allocation data 210, task metadata 212 and utilization data 214 to determine an optimal scheduling of the task (block 305). Event and metrics data collected by data collection module 132 of FIG. 1 are stored as utilization data 214. Resource allocations for tasks previously scheduled by workload scheduler module 204 are stored as resource allocations 210. After schedule optimizer module 208 determines an optimal schedule (block 305) or if the user's task request has no flexibility (block 304), the resulting task schedule (optimal or user-fixed) is used by price estimator module 206 to determine the task execution price, which is presented to the user by user portal module 202 (block 306). The resulting task schedule (and thus the price) is based upon the resources and execution times required by the task.

If the user accepts the price (block 308), workload scheduler module 204 schedules and queues the task for execution on one of queues 136, updates task metadata 212 with data for the newly scheduled task, and updates resource allocations 210 to reflect the resources allocated to the task (block 310), completing method 300 (block 314). If the user rejects the price (block 308) and opts to modify the task scheduling and/or resources used (block 312), method 300 is repeated (blocks 302-308). If the user rejects the price (block 308) and opts to abort the task request altogether without modifying the request (block 312), method 300 completes (block 314).

As previously described, the pricing determined by pricing estimator module 206 is designed to discourage scheduling of tasks and corresponding resources during periods of high or peak use, and to encourage task/resource scheduling during periods of low usage. One example of how this may be achieved is to make the price of system resources inversely proportional to the amount of remaining resources. For example, in at least some embodiments, the combined memory and processor resources of a machine (e.g., the RAM and CPU of virtual machine 130a of FIG. 1) is allocated in minimal 0.1 fractional amounts that are each 1 minute of execution time in duration. Thus, one RAM/CPU resource may be allocated to as many as 10 different tasks within a given minute of execution time. A price is set for this minimal allocation per unit time to create a minimal lease unit price measured in dollars. An example of a variable minimal lease unit that discourages resource usage as more of the resource is allocated would be,

U=A/log(X_{Total}−X_{Allocated}) (1)

wherein for X_{Total} not equal to X_{Allocated},

A is a price factor,

X_{Total} is the total available resource capacity,

X_{Allocated} is the resource capacity already allocated, and

U is the resulting minimal lease unit price for the given resource usage.

If X_{Total} is equal to X_{Allocated}, there is no need to calculate U, as the resource has been fully allocated and is thus unavailable and the request as scheduled would be rejected. This can occur if the user does not allow sufficient flexibility in task scheduling or resources required.

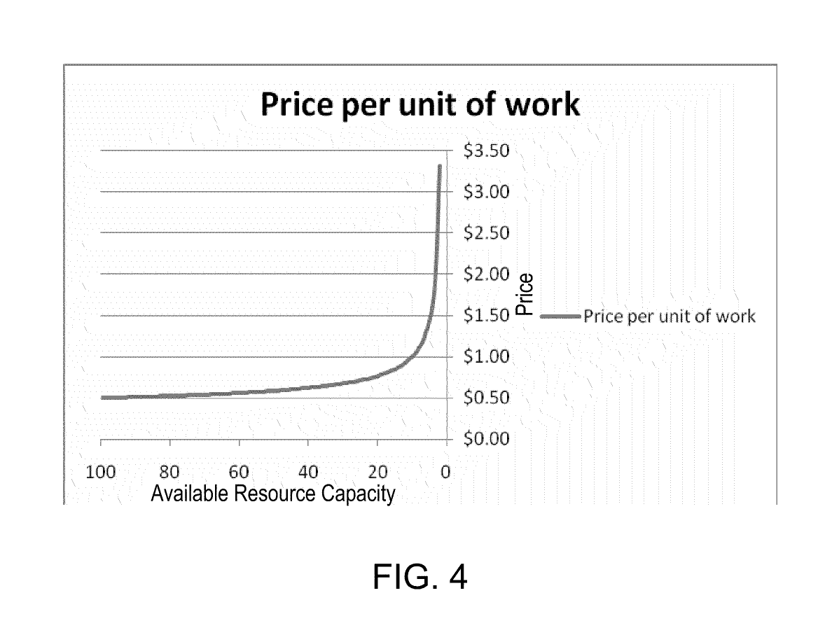

FIG. 4 illustrates an example of dynamic pricing based on equation (1), where price factor A is set to $0.50. As can be seen from the graph, when all 10 allocation units are available (100%), the minimal lease unit price is $0.50. Thus, if a user scheduled a task that required 1 allocation unit for 1 minute at a time of 0% utilization, the cost would be $0.50. If, however, a user attempted to schedule the same task during a period where the RAM/CPU utilization of an available virtual machine was 90%, the 1 allocation unit for 1 minute required by the user would instead cost $1.00. This higher price encourages the user to consider execution times with lower RAM/CPU usage in to reduce the cost of running the task. This also makes more resources available for less flexible, high cost/low lead-time task requests.

It should be noted that the single combined RAM/CPU resource of the above example was presented for simplicity. Those of ordinary skill in the art will recognize that a wide variety of computer system resources may be priced and allocated to tasks fractionally, individually or in combination. Examples of such resources include, but are not limited to, processing bandwidth, volatile memory (e.g., RAM), non-volatile memory (e.g., disk space), network bandwidth, database utilization, instances of a software application and ports used to access a software application. All such pricing and allocation of resources, fractions of resources and combinations of resources are contemplated by the present disclosure.

In at least some embodiments, a user's flexibility in scheduling may be factored into equation (1) to encourage such flexibility. For example, a user may be presented with two options:
1. Allowing reserved time blocks for a task to be discontinuous (workloads may be started and paused and started again) while still requiring that all such time blocks be allocated between a fixed start and end time.
2. Requiring that reserved time blocks for a task must be continuous, but allowing execution to take place within a time window larger than the total execution time of the task.
   For each option, a different discount is applied to scale price factor A. For example, if option 1 is considered more flexible than option 2, a discount for option 1 could be implemented by multiplying price factor A by (3*time required)/(4*time allowed), while a discount for option 2 could be implemented by multiplying price factor A by (time required)/(time allowed). Such a discount structure would thus encourage the user to select the option that provides greater scheduling and resource flexibility. Such flexibility allows schedule optimizer module 208 of FIG. 2 to select an optimal schedule and/or an optimal resource usage, for example, by solving for the lowest mean value of consumed resources over a specified time period. This is useful when the system is asked to compute a price for a new reservation, as it is desirable to offer the most competitive price possible to encourage full utilization of all available resources.

For small numbers of tasks, this optimization may be achieved using exhaustive enumeration of all possible schedules, but for larger numbers of tasks more sophisticated statistical methods may be used (e.g., a Monte Carlo method such as simulated annealing). Other examples of methods suitable for determining an optimal task schedule may include any of a number of deterministic methods (e.g., interval optimization and branch and bound methods), stochastic methods (e.g., basin hopping, stochastic tunneling, parallel tempering and continuation methods) and metaheuristic methods (evolutionary algorithms, swarm-based optimizations, memetic algorithms, reactive search optimizations, differential evolution methods and graduated optimizations). Various other optimization methods may become apparent to those of ordinary skill in the art, and all such methods are contemplated by the present disclosure.

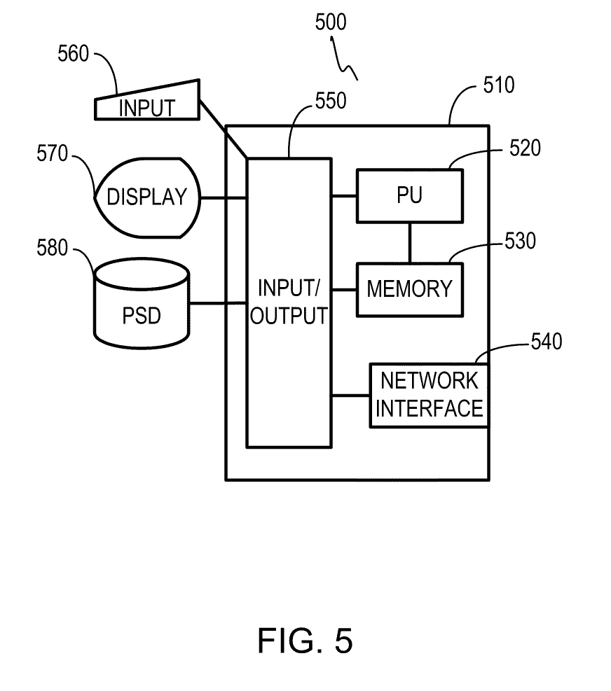

Referring now to FIG. 5, an example computer system 500 is shown that may be used as a reservation system, such as virtual machine 130c of FIG. 1, or as any other virtual or real computer system shown in the figures and described herein. Example computer system 500 may include a programmable control device 510 which may be optionally connected to input unit 560 (e.g., a keyboard, mouse, touch screen, etc.), display device 570 or non-volatile/persistent storage device (PSD) 580 (sometimes referred to as direct access storage device DASD). Also, included with programmable control device 510 is a network interface 540 for communication via a network with other computing and corporate infrastructure devices (see, e.g., network 102 of FIG. 1). Note that network interface 540 may be included within programmable control device 510 or be external to programmable control device 510. In either case, programmable control device 510 will be communicatively coupled to network interface 540. Also note that non-volatile storage unit 580 represents any form of non-volatile storage including, but not limited to, all forms of optical, magnetic and solid-state storage elements.

Programmable control device 510 may be included in a computer system and be programmed to perform methods in accordance with this disclosure (e.g., method 300 illustrated in FIG. 3). Programmable control device 510 includes a processing unit (PU) 520, input-output (I/O) interface 550 and memory 530. Processing unit 520 may include any programmable controller device including, for example, processors of an IBM mainframe (such as a quad-core z10 mainframe microprocessor). Alternatively, in non mainframe systems, examples of processing unit 520 include the Intel Core®, Pentium® and Celeron® processor families from Intel and the Cortex® and ARM® processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 530 may include one or more memory modules and include random access memory (RAM), read only memory (ROM), programmable read only memory (PROM), programmable read-write memory, and solid state memory. One of ordinary skill in the art will also recognize that PU 520 may also include some internal memory including, for example, cache memory.

In addition, acts in accordance with the methods of FIG. 3 may be performed by an example computer system 500 including a single computer processor, a special purpose processor (e.g., a digital signal processor, “DSP”), a plurality of processors coupled by a communications link or a custom designed state machine, or other device capable of executing instructions organized into one or more program modules. Custom designed state machines may be embodied in a hardware device such as an integrated circuit including, but not limited to, application specific integrated circuits (“ASICs”) or field programmable gate array (“FPGAs”).

Storage devices, sometimes called “memory medium,” “computer-usable medium” or “computer-readable storage medium,” are suitable for tangibly embodying program instructions and may include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as network 102 and/or a wireless link.

As evident from the examples presented, at least some of the functionality described herein (e.g., scheduler module 200 of FIGS. 1 and 2), may be performed on computers implemented as virtualized computer systems (e.g., systems implemented using z/VM virtual machine operating system software by IBM), as well as by distributed computer systems (e.g., diskless workstations and netbooks), just to name two examples. All such implementations and variations of a computer system are contemplated by the present disclosure.

The above discussion is meant to illustrate the principles of at least some example embodiments of the claimed subject matter. Various features are occasionally grouped together in a single embodiment for the purpose of streamlining the disclosure. This method of disclosure is not to be interpreted as reflecting an intention that the embodiments of the claimed subject matter require more features than are expressly recited in each claim.

Various changes in the details of the illustrated operational methods are possible without departing from the scope of the claims that follow. For instance, illustrative flow chart steps or process steps of FIG. 3 may perform the identified steps in an order different from that disclosed here. Alternatively, some embodiments may combine the activities described herein as being separate steps. Similarly, one or more of the described steps may be omitted, depending upon the specific operational environment in which the method is being implemented.

Other variations and modifications will become apparent to those of ordinary skill in the art once the above disclosure is fully appreciated. For example, although events and metric data are described as originating, at least in part, from computers such as PCs, mainframes and workstations, other devices or components may also source metric data and/or trigger events. Examples of such devices may include network switches, network routers, disk drives, raid controllers, printers, modems, uninterruptable power supplies and datacenter environmental sensing and control devices. Also, although a mainframe computer system was described in the examples presented, the systems and methods disclosed are not limited to mainframe computer systems. Many other types of computer systems and topologies may be equally suitable for implementing the systems, such as any of a variety of distributed computer systems interconnected by one or more communication networks (e.g., Amazon's EC2 cloud topology). All such computer systems and topologies are contemplated by the present disclosure. It is intended that the following claims be interpreted to include all such variations and modifications.

What is claimed is:

1. A method for demand-driven computer system resource optimization, the method comprising:
receiving, by a processor within a computer system, a request to execute a task, said request comprising a required execution time and a resource requirement for said task;
selecting, by the processor, a prospective execution schedule that meets the required execution time and a computer system resource that meets the resource requirement;
determining, in response to the request, a price for executing the task using the computer system resource according to the prospective execution schedule; and
scheduling, by the processor, the task to execute using the computer system resource according to the prospective execution schedule if an indication of acceptance of the price is received;
wherein said price varies as a function of availability of the computer system resource at one or more times corresponding to the prospective execution schedule, said availability being measured at the time the price is determined.

2. The method of claim 1, wherein selecting the prospective execution schedule comprises:
identifying a plurality of prospective execution schedules if the request allows for variations in the required execution time; and
selecting the prospective execution schedule from the plurality of prospective execution schedules;
wherein each of the plurality of prospective execution schedules reflects a different variation of the required execution time.

3. The method of claim 2, wherein the act of selecting the prospective execution schedule results in a lowest mean value of allocated resources over a specified time period when compared to selecting at least one other prospective execution schedule of the plurality of prospective execution schedules.

4. The method of claim 2, wherein the act of selecting the prospective execution schedule is based at least in part on an analysis of the plurality of prospective execution schedules, the analysis comprising a method selected from the group consisting of a deterministic method, a stochastic method and a metaheuristic method.

5. The method of claim 1, wherein the act of selecting the computer system resource comprises:
identifying a plurality of computer system resources if the request allows for variations in the resource requirement; and
selecting the computer system resource from the plurality of computer system resources;
wherein each of the plurality of computer resources reflects a different variation of the resource requirement.

6. The method of claim 5, wherein the act of selecting the computer system resource results in a lowest mean value of allocated resources over a specified time period when compared to selecting at least one other computer resource of the plurality of computer resources.

7. The method of claim 5, wherein the act of selecting the computer resource is based at least in part on an analysis of the plurality of computer resources, the analysis comprising a method selected from the group consisting of a deterministic method, a stochastic method and a metaheuristic method.

8. The method of claim 1, wherein if an indication of rejection of the price is received instead of an indication of acceptance, the method further comprises:
receiving, by the processor, a second request to execute a task, said request comprising a second required execution time for said task; and
repeating the selecting, determining and scheduling steps of claim 1 using the second required execution time.

9. The method of claim 1, wherein if an indication of rejection of the price is received instead of an indication of acceptance, the method further comprises:
receiving, by the processor, a second request to execute a task, said request comprising a second resource requirement for said task; and
repeating the selecting, determining and scheduling steps of claim 1 using the second resource requirement.

10. A computer-readable storage medium comprising software that can be executed on a processor to cause the processor to perform the method of claim 1.

11. A networked computer system, comprising:
a communication network; and
a plurality of computer systems each coupled to the communication network, at least one computer system of the plurality of computer systems comprising:
a processing unit that:
selects a prospective execution schedule that meets the required execution time and a computer system resource that meets the resource requirement;
determines a price, in response to the request, for executing the task using the computer system resource according to the prospective execution schedule; and
schedules the task to execute using the computer system resource according to the prospective execution schedule if the processing unit receives an indication of acceptance of the price; and
a network interface communicatively coupled to the communication network and the processing unit;
wherein said price increases as a function of decreasing availability of the computer system resource at one or more times corresponding to the prospective execution schedule, said availability being measured at the time the price is determined.

12. The networked computer system of claim 11, the at least one computer system further comprising:
a non-volatile storage device comprising utilization data reflecting current and past utilization of resources of the networked computer system and further comprising resource allocations and task metadata of tasks previously scheduled for execution;
wherein the processing unit selects the prospective execution schedule and the computer system resource that meet the requirements of said request based at least in part on the utilization data, resource allocations and task metadata stored on the non-volatile storage device.

13. The networked computer system of claim 11, wherein the processing unit further:
identifies a plurality of prospective execution schedules if the request allows for variations in the required execution time; and
selects the prospective execution schedule from the plurality of prospective execution schedules;
wherein each of the plurality of prospective execution schedules reflects a different variation of the required execution time.

14. The networked computer system of claim 13, wherein the processing unit selects the prospective execution schedule that results in a lowest mean value of allocated resources over a specified time period when compared to a selection of at least one other prospective execution schedule of the plurality of prospective execution schedules.

15. The networked computer system of claim 13, wherein the processing unit selects the prospective execution schedule based at least in part on an analysis of the plurality of prospective execution schedules, the analysis comprising a method selected from the group consisting of a deterministic method, a stochastic method and a metaheuristic method.

16. The networked computer system of claim 11, wherein the processing unit further:
identifies a plurality of computer system resources if the request allows for variations in the resource requirement; and
selects the computer system resource from the plurality of computer system resources;
wherein each of the plurality of computer resources reflects a different variation of the resource requirement.

17. The networked computer system of claim 16, wherein the processing unit selects the computer system resource that results in a lowest mean value of allocated resources over a specified time period when compared to a selection of at least one other computer resource of the plurality of computer resources.

18. The networked computer system of claim 16, wherein the processing unit selects the computer resource based at least in part on an analysis of the plurality of computer resources, the analysis comprising a method selected from the group consisting of a deterministic method, a stochastic method and a metaheuristic method.

19. The networked computer system of claim 11, wherein if the processor receives an indication of a rejection of the price, the processor further:
receives a second request to execute a task, said request comprising a second required execution time for said task; and
repeats the selection, determination and scheduling performed in claim 11 using the second required execution time.

20. The networked computer system of claim 11, wherein if the processor receives an indication of a rejection of the price, the processor further:
receives a second request to execute a task, said request comprising a second resource requirement for said task; and
repeats the selection, determination and scheduling performed in claim 11 using the second resource requirement.
